(19) United States
(12) Patent Application Publication
(10) Pub. No.: US 2013/0335425 A1
(43) Pub. Date: Dec. 19, 2013

(54) Systems and Methods for Combining Animations

(71) Applicant: Chet Spencer Haase, Pleasanton, CA (US)

(72) Inventor: Chet Spencer Haase, Pleasanton, CA (US)

(73) Assignee: Adobe Systems Incorporated

(21) Appl. No.: 12/534,301

(22) Filed: Aug. 3, 2009

Related U.S. Application Data
(60) Provisional application No. 61/156,623, filed on Mar. 2, 2009.

(51) Int. Cl. G06T 13/00

(52) U.S. Cl. 345/473

(57) ABSTRACT

Systems and methods are disclosed to facilitate a user's ability to create animations. Improved software applications, for example, can facilitate a user's ability to create complex animations by allowing the user to separately declare multiple simple animations, such as individual from/to animations, and then combine these individual animations into a complex animation, such as into multi-part, key frame-based animation. Multiple simple animations can be combined into a single multi-part animation that defines time/value pairs (e.g., keyframes) specifying the values of one or more properties at certain times. Using animations defined in terms of several time/value pairs such as key frames can facilitates the creation of a single animation that describes a motion path that an object will take through several intermediate values between its begin and end points and that involves multiple properties that are changing.

### RELATED APPLICATION

This application is a non-provisional application claiming priority to U.S. Provisional Patent Application No. 61/156,623 filed Mar. 2, 2009, the disclosure of which is herein incorporated by reference.

### FIELD

This disclosure generally relates to computer software that runs, displays, provides, or otherwise uses electronic content including animations.

### BACKGROUND

Existing software allows users to author and edit computer content involving animation. The term “animation” refers to varying over time one or more visual, numeric, or other properties, including but not limited to, location coordinates, variables, strings, and matrices. Animation can include any time-based operation where something changes. An animation may be displayed on a computer screen or other electronic display. For example, an animation may cause an object to translate, swing, rotate, scale, or otherwise change its appearance or location on a display by changing the object's properties. Animations can be used, for example, to make a ball appear to bounce on a display screen by changing the ball's position properties over time, e.g., the ball's y-coordinate position in an x,y position space can change over time. Animations may also cause displayed characters or values to change, e.g., “2” changes to “4” changes to “9” etc. An animation can be implemented as a single change, e.g., set the x-coordinate position of a displayed ball to 10. An animation can also be implemented as multiple changes, e.g., set the x-coordinate to 10 at time 1, set the x-coordinate to 12 at time 2, etc. An animation can be implemented with respect to changes to one or more existing values, e.g., set the x-coordinate to its current value plus 3, etc. In some cases, an animation may comprise a discrete set of changes made with relative frequency to appear continuous, e.g., changing the position of a ball 24 times per second, etc.

Various software applications facilitate a user's ability to define and change animations, for example, by allowing simple animations to be easily specified in terms of a few important attributes. For example, Adobe® Flex® effects can be specified as simple from/to animations, where some property value or values change from a beginning value to an end value over the duration. For example, a user simply specifies the initial value, the duration, and the end value of the property (such as, for example, change property x from 0 to 10 over 500 seconds). In some circumstances, one or both of the start/end values can be determined dynamically and therefore need not always be supplied. For example, if a user wants to move an object to some location, the ‘from’ location can be omitted and the system will automatically take the start location from wherever the object is. Also, Adobe® Flex® has a concept of ‘states’ which define property values of the objects in those states (e.g., in ‘state1’ an object may have an x value of 100, and in ‘state2’ that object's x value may be 200). If an animation is run as a part of changing states (i.e., a “state transition”), then the system can derive the values, such as the end value, from the state information. Generally, a user need not supply either a start value or an end value. In circumstances in which an animation is defined simply, for example in terms of an initial value, a duration, and an end value, the animation may involve incrementally changing the value of the property over that time period, for example by determining appropriate intermediate values. In the above example, the value of x after 250 seconds may be set to 5, etc. This mechanism for specifying a simple animation in terms of a few attributes is generally easy to use but lacks flexibility with respect to defining more complicated animations, such as those in which the value of a property changes to specified intermediate values.

Combining animations is necessary in a variety of circumstances. For example, a move and a rotate defined for an object may need to be combined since the move and rotate may try to simultaneously set the object location. This interference can be avoided by combining those animations into a single operation. For example, a single transformation can set the object's properties at necessary time increments. Another example involves a series of sequential moves and a rotate. If, for example, a first move happens for one second and then a second move happens for another second and a rotate occurs during the entire time, i.e., for two seconds, there is a need to combine all of these animations. This is because both the first move and the second move must be combined with the same rotate. Existing animation applications fail to adequately facilitate creation and use of these types of combined animations. Generally, there is a need for improved techniques for combining different, overlapping, and/or sequential animations into single, complex animations, including animations involving multiple steps or key frames.

### SUMMARY

Systems and methods are disclosed to facilitate a user's ability to create animations. Improved software applications, for example, can facilitate a user's ability to create complex animations by allowing the user to separately declare multiple simple animations, such as individual from/to animations, and then combine these individual animations into a complex animation, such as into multi-part, key frame-based animation. Multiple simple animations can be combined into a single multi-part animation that defines time/value pairs (e.g., keyframes) specifying the values of one or more properties at certain times. Using animations defined in terms of several time/value pairs such as key frames can facilitates the creation of a single animation that describes a motion path that an object will take through several intermediate values between its begin and end points and that involves multiple properties that are changing.

One exemplary embodiment is a method that involves identifying animations to be combined into a combined animation and creating the combined animation by combining two or more keyframe sequences defining those animations. The combined animation can be provided in a computer readable medium defining content, that, when displayed, the content displays the combined animation. The keyframe sequences used to create the combined animation can be received as user input or can be converted from animations specified in other ways. For example, the method may involve, prior to creating the combined animation, creating one or more of the keyframe sequences using one or more of the animations, at least of which is received in terms of a from value and a to value, i.e., a simple from/to animation.

Another exemplary embodiment is a method that involves receiving a first animation, a second animation, and a third animation, on a computing device, where the first animation and second animation are of a same type of animation operation (e.g., both a translation, both a rotation, or both a scaling operation, etc.). The method further involves identifying that combining the first animation and the third animation avoids a first conflict and that combining the second animation and the third animation avoids a second conflict. Based on the existence of these conflicts, the method may determine to combine the animations, for example, by creating a first keyframe sequence combining the first animation and the second animation, creating a second keyframe sequence comprising the third animation, and combining the first keyframe sequence and the second keyframe sequence into a combined animation. The method can also involve providing the combined animation in a computer readable medium defining content, wherein, when displayed, the content displays the combined animation.

These exemplary embodiments are mentioned not to limit or define the disclosure, but to provide examples of embodiments to aid understanding thereof. Embodiments are discussed in the Detailed Description, and further description is provided there. Advantages offered by the various embodiments may be further understood by examining this specification.

### BRIEF DESCRIPTION OF THE FIGURES

These and other features, aspects, and advantages of the present disclosure are better understood when the following Detailed Description is read with reference to the accompanying drawings, wherein:

FIGS. 1A-D are charts of values illustrating an exemplary combination of simple animations according to certain embodiments;

FIG. 2 is a system diagram illustrating an illustrative computing environment 5 according to certain embodiments;

FIG. 3 is a flow chart illustrating an exemplary method of combining animations according to certain embodiments; and

FIG. 4 is a flow chart illustrating an exemplary method of using keyframes to create a combined animation according to certain embodiments.

### DETAILED DESCRIPTION

Systems and methods are disclosed to facilitate a user's ability to define and change animations. In some embodiments, multiple simple animations are combined into a single multi-part animation. For example, such multi-part animations may define several time/value pairs, each defining the value of one or more properties at an instance along a timeline. A key frame is an example of such a time value pair. A “key frame” defines a value (or values) that some property will have when the animation reaches a specified time. A set of key frames can be used to define an animation of an object in which the object takes on the values in the key frames at the defined key frame times and takes on interpolated values between the values specified in key frames during the time intervals between key frames. Using animations defined in terms of several time/value pairs such as key frames facilitates the ability to have a single animation that describes a motion path that an object will take through several intermediate values between its begin and end points.

Improved software applications can also facilitate a user's ability to define and change multi-part and other complex animations by allowing the user to do so by simply declaring or otherwise defining multiple simple animations. For example, a software application may facilitate a user's ability to declare individual from/to animations. The software application can then combine these individual animations into a complex animation, such as into multi-part, key frame-based animation. Many different animations on the same object can be combined into one animation that controls all of the changes to that object. In certain embodiments, this combination of multiple animations into one is handled by converting from/to information into appropriate key frame sequences and then inserting these key frame sequences into the larger animation.

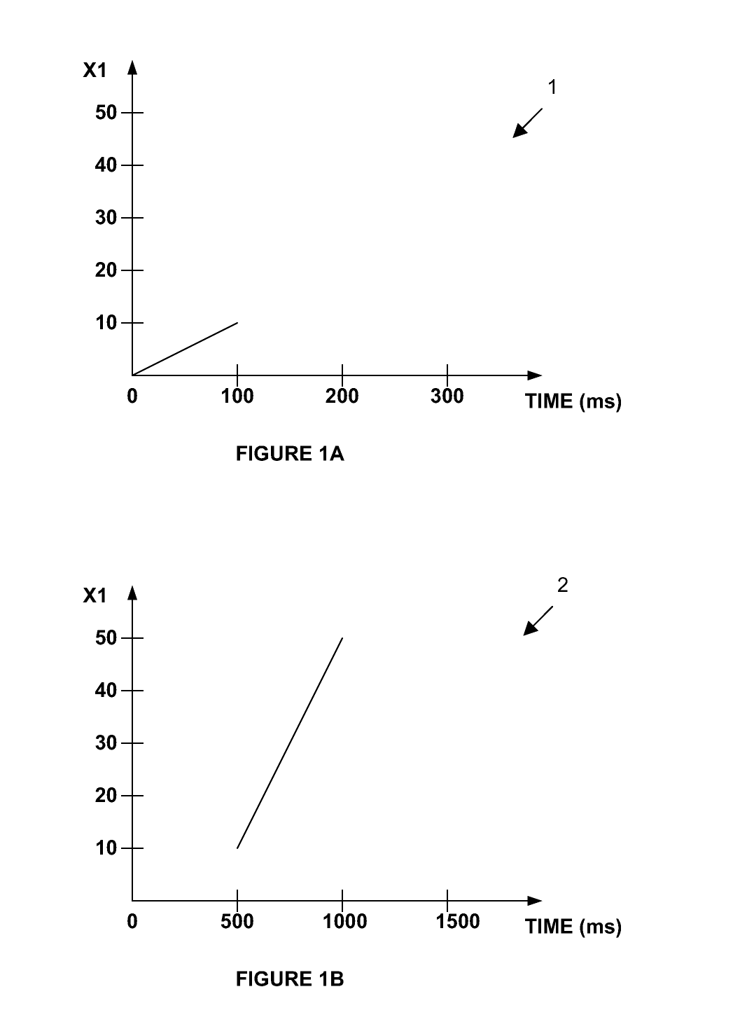

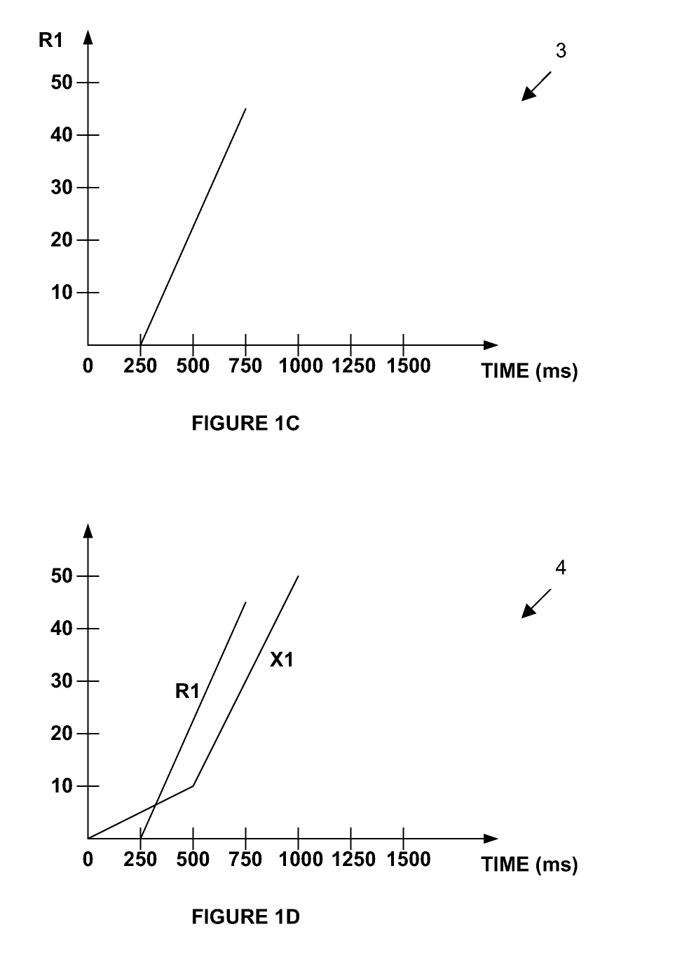

Referring now to the drawings in which like numerals indicate like elements throughout the several Figures, FIGS. 1A-D illustrate an exemplary combination of simple animations. In this example, a software application may receive input or parameters defining three simple animations. A first simple animation, the values of which are illustrated in FIG. 1A, specifies a change of property X1 of an Object O1 from X=0 at time T0 ms to X=10 at time T500 ms. A second simple animation, the values of which are illustrated in FIG. 1B, specifies a delay for a time 500 ms and then a change of property X1 of Object O1 from X=10 to X=50 at time T1000 ms. A third simple animation, the values of which are illustrated in FIG. 1C, specifies a delay of 250 ms and then a rotation of Object O1 from an angle of 0 degrees to and angle of 45 degrees over a duration of 500 ms. These simply-defined animations can be converted (automatically or with user input) into a single animation, the values of which are illustrated in FIG. 1D.

Such an animation may include, for example, two key frame sequences. The first key frame sequence specifies key frames for the X1 property of O1: X1=0 at T=0, X1=10 at T=500, and X1=50 at T=1000. The second key frame sequence specifies values for rotation R1 of O1: R1=0 at T=250, and R1=45 at T=750.

This is merely a specific example that does not limit the scope or context of other embodiments. Various alternative implementations can be utilized. In some implementations, for example, key frames are not used and the parts of the multi-part animation or complex animation is specified in other terms. These illustrative examples are given to introduce the reader to the general subject matter discussed herein and is not intended to limit the scope of the disclosed concepts. The following sections describe various additional embodiments and examples.

### Illustrative Computing Environment

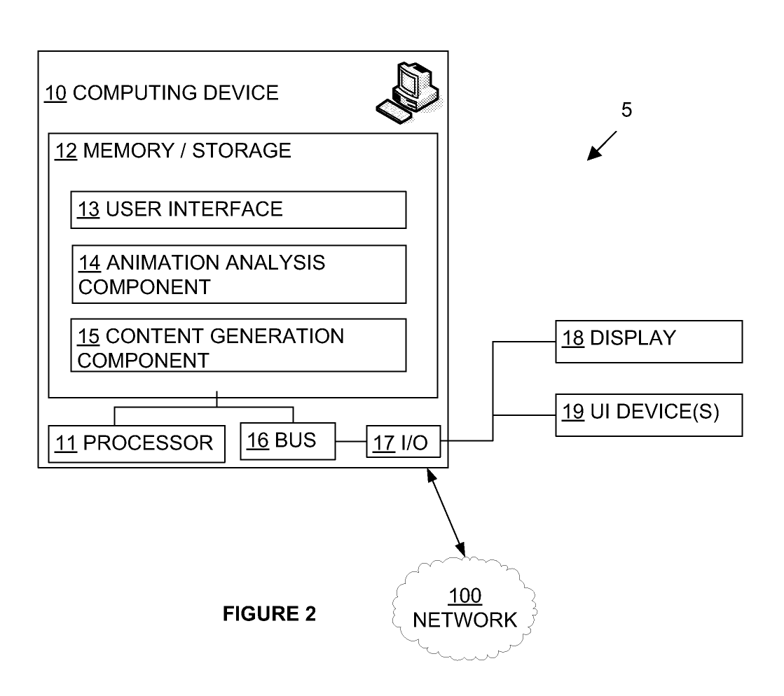

FIG. 2 is a system diagram illustrating an illustrative computing environment 5 according to certain embodiments. Other embodiments may be utilized. The computing environment 5 shown in FIG. 2 comprises a computing device 10 that is connected to a wired or wireless network 100. Exemplary applications that execute on the computing device 10 are shown as functional or storage components residing in memory 12. The memory 12 may be transient or persistent. As is known to one of skill in the art, such applications may be resident in any suitable computer-readable medium and execute on any suitable processor. For example, the computing device 10 may comprise a computer-readable medium such as a random access memory (RAM) coupled to a processor 11 that executes computer-executable program instructions and/or accesses information stored in memory 12. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may comprise processor-specific instructions generated by a compiler and/or an interpreter from code written in any suitable computer-programming language, including, for example, C, C++, C#, Visual Basic, Java, Python, Perl, JavaScript, and ActionScript.

The network 100 shown comprises the Internet. In other embodiments, other networks, intranets, combinations of networks, or no network may be used. The computing device 10 may also comprise a number of external or internal devices such as a mouse, a CD-ROM, DVD, a keyboard, a display, audio speakers, or other input or output devices. For example, the computing device 10 includes input output connections 17, connecting a display 18 and various user interface devices 19. The computer device 10, depicted as single computer system, may be implemented as a network of computers, servers, or processors. Examples of a server device are servers, mainframe computers, networked computers, a processor-based device, and similar types of systems and devices.

A computing device, such as exemplary computing device 10, can utilize various functional components to implement one or more of the features described herein. Computing device 10 has a user interface 13 for receiving (and possibly displaying) animations, including, in this example, animations having different types of animation operation, e.g., translation, rotation, scaling, etc. Computing device 10 may further have an animation analysis component 14 for identifying animations that should and/or can be combined to avoid conflicts and other issues. An animation analysis component 14, another component of computing device 10, or other component that is otherwise accessible may also be used to create a combined animation in accordance with one or more of the techniques described herein. For example, animation analysis component 14 may identify that combining a first animation and a third animation avoids a first conflict and that combining a second animation and the third animation avoids a second conflict and then create a first keyframe sequence with the first animation and the second animation, create a second keyframe sequence with the third animation, and then combine the first keyframe sequence and the second keyframe sequence into a combined animation.

In circumstances in which animations are used in content being created, computing device 10 may further have a content generation component 15 that provides animations and/or other aspects of content, typically, by providing such content in a computer readable medium defining the content. The content can be provided, for example, for display on computing device 10 and/or other electronic devices. Accordingly, one aspect of certain embodiments is facilitating the creation of electronic content that includes animation.

This illustrative computing environment 5 is provided merely to illustrate a potential environment that can be used to implement certain embodiments. Other computing devices and configurations may alternatively or additionally be utilized.

### Exemplary Methods of Combining Animations

Returning to the example of combining the simple animations described above and illustrated in charts 1, 2, 3 of FIGS. 1A, 1B, and 1C, respectively. Those simple animations can be used as input to generate a combined animation, for example, one comprising two key frame sequences: a key frame sequence for the X1 property and a key frame sequence for the rotation R1. In this example, these independent key frame sequences can be processed as part of a single animation that processes multiple key frame sequences, e.g., for example, on multiple properties of a single object. In this case, the animation is complicated and comprises a change of at least the X1 property through a specified intermediate point, i.e., X1=10 at time 500 ms.

Combining multiple, simply-specified animations into a single animation can be accomplished in a variety of ways. In certain embodiments, a computing system receives the multiple, simply-specified animations and uses structured logic to be able to convert the animations into keyframes that are then combined into a key-framed-based complex animation. Such logic, which may be implemented as computer software or hardware, can be structured to accept animations specified in one or more different formats, involving multiple values including intermediate values, and/or to account for delays, durations, and other timing information to coordinate the relative timing of the simply-specified animations in the combined animation. Logic may also be provided to modify received data structures into key frame structures.

Converting multiple, simply-specified animations into a single animation can be accomplished automatically by a software application that a developer uses to create animation such that the developer is not required to be aware of the conversion. Alternatively, a software application may receive the input animations, identify that a combination of animations is possible, and present the user with an option to combine the animations, such as, for example, by presenting a wizard that walks the user through a series of options for combining the animations.

Different graphical animation operations including, but not limited to, translations, rotations, and scaling, are amenable to combination using one or more of the techniques described herein. The term “scaling” is used here to refer to changes to the width, height, diameter or other scale attribute of a graphical object. Simple graphical animations may also identify other attributes in addition to the features described in the preceding examples, such as, for example, identifying an “auto center” command that may select a specific point of rotation (e.g., the center of the object).

Moreover, these exemplary two dimensional graphical animation operations have three dimensional versions which can also be combined in accordance with one or more of the techniques described herein. Two dimensional and three dimensional animations can also be combined with one another. Accordingly, in another exemplary combination, a user may specify a simple translate (i.e., move) animation and two simple scale animations, that are subsequently combined into a single combined animation.

In certain embodiments, animations are separately specified and combined together by converting the animations to keyframe based values according to how the animations are used with respect to one or more timelines. The timeline(s) can be referenced to identify the time values used in the keyframes, for example. Accordingly, two pieces of media content can be combined together, each having different timelines, and one or more of the animations from the different pieces of media content can be automatically combined together according to analysis of one or more timelines that reveal how the pieces are (or should be) combined. In certain embodiments, different developers are able to separately work on certain animations and content and then combine their animations and content without having to manually address whether there are conflicts in the animations or how such animations need to or can be combined to ensure that the one or more functional or aesthetic benefits are provided.

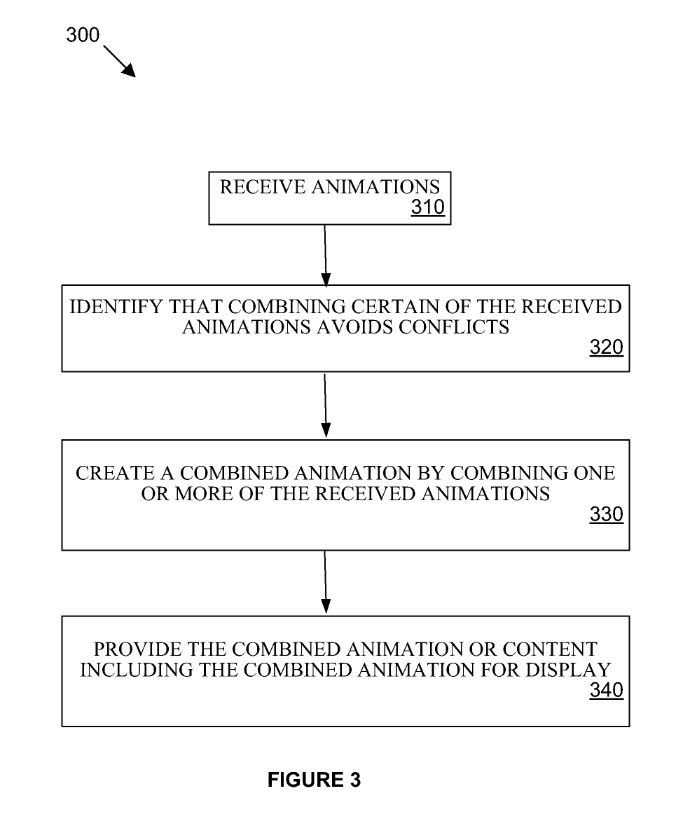

FIG. 3 is a flow chart illustrating an exemplary method 300 of combining animations according to certain embodiments. The method 300 involves receiving animations, as illustrated in block 310. For example, animations may be specified by a content developer developing electronic content that will comprise the animations. As a specific example, a content developer may use user interface 13 of a computing device 10 of FIG. 2 to specify individual animations for use in a piece of content being created on the computing device 10 for distribution and use over network 100. As another specific example, animations may be identified automatically from a piece of electronic content that is already created. For example, the source or code specifying such content may be interrogated and commands corresponding to the animations identified.

In one embodiment, at least three animations are received, including at least a first animation and a second animation that are of a same type of animation operation, e.g., translation, rotation, or scaling, etc. A third animation that is also received may be of a different type of animation operation. As a specific example, the third animation may be a rotation and the first animation and the second animation may be translations. As another specific example, the third animation may be a scaling and the first animation and the second animation may be translations. In another specific example, receiving one or more of the animations may involve receiving input specifying at most a first value of a variable at animation start and a second value of the variable at animation end. Accordingly, one or more of the received animation may be specified as simple motion paths with defined (or implied) start and end values and without any specified intermediate values.

The method 300 further involves identifying that combining certain of the received animations avoids conflicts, as illustrated in block 320. For example, such identifying may involve recognizing that two animations require modification of an object (or one or more of an object's properties) at the same time or during a same time period. As a more specific example, two or more animations may be received that specify time-overlapping changes to a property of an object. Potential conflicts can be identified expressly, simply by identifying that two or more animations overlap, or otherwise. Identification of conflicts can be performed by any suitable component. In the example of FIG. 2, an animation analysis component 14 of the computing device 10 may be used to identify such conflicts. Other embodiments can involve identifying conflicts by other means on a local computing device or elsewhere, as will be understood by those of skill in the art.

The method 300 further involves creating a combined animation by combining one or more of the received animations, as illustrated in block 330. Creating a combined animation can be accomplished in a variety of ways and may involve one or more different computing devices or components. In one exemplary embodiment, a component, such as animation analysis component 14 of FIG. 2, is used to create one or more combined animations that are than incorporated into content being developed or otherwise used.

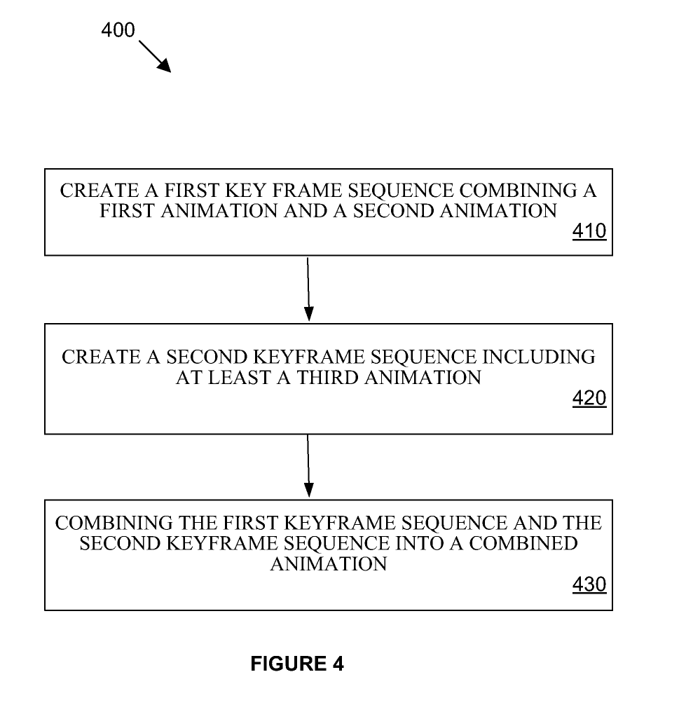

FIG. 4 is a flow chart illustrating an exemplary method 400 of using keyframes to create a combined animation according to certain embodiments. This example is discussed in the context of three animations that have been received. Other embodiments may involve combining only two animations or may involve combining some or all of three or more animations.

The method 400 involves creating a first keyframe sequence combining the first animation and the second animation, as shown in block 410. Typically, although not always, the first animation and second animation will specify the same type of animation operation. For example, this may involve converting from/to information specifying at least one of the first animation or second animation into one or more keyframes. The keyframe sequence can thus combine animations that do not necessarily include intermediate specified values into a sequence that, by including multiple keyframe values, functions to specify a complicated motion path involving intermediate values. Animations of a same type of animation operation (e.g., translation, rotation, scaling, etc.) for the same object or object property can and will typically (but not necessarily always) be combining into a single keyframe sequence. In certain circumstances, animations of different animation operations can also be combined in to a single keyframe sequence.

The method 400 further involves creating a second keyframe sequence comprising at least a third animation, as illustrated in block 420. As with the other exemplary keyframe creation described above, this may involve converting from/to values into values in one or more keyframes that together make up the sequence of keyframes. In a particular example, if animations are received as input specifying at most a first value of a variable at animation start and a second value of the variable at animation end, the method 400 may involve creating keyframe sequences that each comprise animation start and/or end values. For example, a single keyframe sequence may be created and include start and end values for two or more simply specified animations.

The method 400 further involves combining the first keyframe sequence and the second keyframe sequence into a combined animation, as illustrated in block 430. Multiple keyframe sequences, for example, one for each of the different types of animation operations being combined, can be combined into a single combined animation. In certain embodiments, animations are selectively combined to avoid conflicts, other issues, and/or to enhance efficiency or provide other benefits in content that is being created or modified.

Returning to FIG. 3, once a combined animation has been created, the method 300 further involves providing the combined animation or content including the combined animation for display, as illustrated in block 340. For example, this may involve providing the combined animation in a computer readable medium defining content, wherein, when displayed, the content displays the combined animation. In circumstances in which animations are used in content being created on computing device 10 of FIG. 2, the content generation component 15 may provide animations and/or other aspects of content, for display on computing device 10 and/or other electronic devices.

### General

Numerous specific details are set forth herein to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing platform, such as one or more computers or a similar electronic computing device or devices, that manipulate or transform data represented as physical electronic or magnetic quantities within memories, registers, or other information storage devices, transmission devices, or display devices of the computing platform.

The various systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software, that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

As noted above, a computing device may access one or more computer-readable media that tangibly embody computer-readable instructions which, when executed by at least one computer, cause the at least one computer to implement one or more embodiments of the present subject matter. When software is utilized, the software may comprise one or more components, processes, and/or applications. Additionally or alternatively to software, the computing device(s) may comprise circuitry that renders the device(s) operative to implement one or more of the methods of the present subject matter.

Examples of computing devices include, but are not limited to, servers, personal computers, personal digital assistants (PDAs), cellular telephones, televisions, television set-top boxes, and portable music players. Computing devices may be integrated into other devices, e.g. “smart” appliances, automobiles, kiosks, and the like.

The inherent flexibility of computer-based systems allows for a great variety of possible configurations, combinations, and divisions of tasks and functionality between and among components. For instance, processes discussed herein may be implemented using a single computing device or multiple computing devices working in combination. Databases and applications may be implemented on a single system or distributed across multiple systems. Distributed components may operate sequentially or in parallel.

When data is obtained or accessed as between a first and second computer system or components thereof, the actual data may travel between the systems directly or indirectly. For example, if a first computer accesses data from a second computer, the access may involve one or more intermediary computers, proxies, and the like. The actual data may move between the first and second computers, or the first computer may provide a pointer or metafile that the second computer uses to access the actual data from a computer other than the first computer, for instance. Data may be “pulled” via a request, or “pushed” without a request in various embodiments.

The technology referenced herein also makes reference to communicating data between components or systems. It should be appreciated that such communications may occur over any suitable number or type of networks or links, including, but not limited to, a dial-in network, a local area network (LAN), wide area network (WAN), public switched telephone network (PSTN), the Internet, an intranet or any combination of hard-wired and/or wireless communication links.

Any suitable tangible computer-readable medium or media may be used to implement or practice the presently-disclosed subject matter, including, but not limited to, diskettes, drives, magnetic-based storage media, optical storage media, including disks (including CD-ROMS, DVD-ROMS, and variants thereof), flash, RAM, ROM, and other memory devices.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A computer-implemented method comprising:
identifying, by a computing device, animations to be combined into a combined animation on a computing device;
creating, by the computing device, the combined animation by combining two or more keyframe animations, wherein at least one of the keyframe animations is created using at least one animation that is not defined as a keyframe sequence; and
providing the combined animation in a computer readable medium defining content, wherein, when displayed, the content displays the combined animation.

2. (canceled)

3. The method of claim 2 wherein the at least one animation not defined as a keyframe sequence are defined by from/to values.

4. A computer-implemented method comprising:
receiving a first animation, a second animation, and a third animation, on a computing device, wherein the first animation and second animation are of a same type of animation operation, and where at least one of the first animation, second animation, and third animation is created using at least one animation that is not defined as a keyframe sequence;
identifying, by the computing device, that combining the first animation and the third animation avoids a first conflict and that combining the second animation and the third animation avoids a second conflict;
creating, by the computing device, a first keyframe sequence combining the first animation and the second animation;
creating, by the computing device, a second keyframe sequence comprising the third animation;
combining, by the computing device, the first keyframe sequence and the second keyframe sequence into a combined animation; and
providing the combined animation in a computer readable medium defining content, wherein, when displayed, the content displays the combined animation.

5. The method of claim 4 wherein receiving the first animation, second animation, and third animation comprises, for each of the first animation, second animation, and third animation, receiving input specifying at most a first value of a variable at animation start and a second value of the variable at animation end.

6. The method of claim 5 wherein:
creating the first keyframe sequence comprises using the first value and second value of each of the first animation and second animation; and
creating the second keyframe sequence comprises using the first value and second value of the third animation.

7. The method of claim 4 wherein the type of animation operation of each of the first animation, second animation, and third animation is one of a translation, a rotation, or a scaling.

8. The method of claim 4 wherein creating the first keyframe sequence combining the first animation and the second animation comprises converting from/to information specifying at least one of the first animation or second animation into one or more keyframes.

9. The method of claim 4 wherein the third animation is not of the same type of animation operation as the first animation and the second animation.

10. The method of claim 9, wherein the third animation is a rotation and the first animation and the second animation are translations.

11. The method of claim 9, wherein the third animation is a scaling and the first animation and the second animation are translations.

12. A computer apparatus comprising:
a user interface for receiving a first animation, a second animation, and a third animation, wherein the first animation and second animation are of a same type of animation operation;
an animation analysis component:
identifying, by a computing device, that combining the first animation and the third animation avoids a first conflict and that combining the second animation and the third animation avoids a second conflict, wherein at least one of the first animation, the second animation, and the third animation is created using at least one animation that is not defined as a keyframe sequence;
creating a first keyframe sequence combining the first animation and the second animation;
creating a second keyframe sequence comprising the third animation; and
combining the first keyframe sequence and the second keyframe sequence into a combined animation; and
a content generation component providing the combined animation in a computer readable medium defining content, wherein, when displayed, the content displays the combined animation.

13. The computer apparatus of claim 12 wherein receiving the first animation, second animation, and third animation comprises, for each of the first animation, second animation, and third animation, receiving input specifying at most a first value of a variable at animation start and a second value of the variable at animation end.

14. The computer apparatus of claim 13 wherein:
creating the first keyframe sequence comprises using the first value and second value of each of the first animation and second animation; and
creating the second keyframe sequence comprises using the first value and second value of the third animation.

15. The computer apparatus of claim 12 wherein the type of animation operation of each of the first animation, second animation, and third animation is one of a translation, a rotation, or a scaling.

16. The computer apparatus of claim 12 wherein creating the first keyframe sequence combining the first animation and the second animation comprises converting from/to information specifying at least one of the first animation or second animation into one or more keyframes.

17. The computer apparatus of claim 12 wherein the third animation is not of the same type of animation operation as the first animation and the second animation.

18. A computer-readable medium on which is encoded program code, the program code comprising:
program code for receiving a first animation, a second animation, and a third animation, on a computing device, wherein the first animation and second animation are of a same type of animation operation, and wherein at least one of the first animation, the second animation, and the third animation is created using at least one animation that is not defined as a keyframe sequence;
program code for identifying, by the computing device, that combining the first animation and the third animation avoids a first conflict and that combining the second animation and the third animation avoids a second conflict;
program code for creating a first keyframe sequence combining the first animation and the second animation;
program code for creating a second keyframe sequence comprising the third animation;
program code for combining the first keyframe sequence and the second keyframe sequence into a combined animation; and
program code for providing the combined animation in a computer readable medium defining content, wherein, when displayed, the content displays the combined animation.

19. The computer-readable medium of claim 18 wherein receiving the first animation, second animation, and third animation comprises, for each of the first animation, second animation, and third animation, receiving input specifying at most a first value of a variable at animation start and a second value of the variable at animation end.

20. The computer-readable medium of claim 19 wherein:
creating the first keyframe sequence comprises using the first value and second value of each of the first animation and second animation; and
creating the second keyframe sequence comprises using the first value and second value of the third animation.

21. The computer-readable medium of claim 18 wherein the type of animation operation of each of the first animation, second animation, and third animation is one of a translation, a rotation, or a scaling.

22. The computer-readable medium of claim 18 wherein creating the first keyframe sequence combining the first animation and the second animation comprises converting from/to information specifying at least one of the first animation or second animation into one or more keyframes.

23. The computer-readable medium of claim 18 wherein the third animation is not of the same type of animation operation as the first animation and the second animation.
